(19) United States
(12) Patent Application Publication
(10) Pub. No.: US 2025/0180234 A1
(43) Pub. Date: Jun. 5, 2025

(54) Dynamic Control System and Control Method Suitable for Ventilation of Fully Buried Sewage Treatment Plant

(71) Applicant: CHINA MCC5 GROUP CORP. LTD, Chengdu, Sichuan (CN)

(72) Inventors: Peilin LI, Chengdu, Sichuan (CN); Jiri ZHOU, Chengdu, Sichuan (CN); Hanlin YANG, Chengdu, Sichuan (CN); Tao WANG, Chengdu, Sichuan (CN); Gen SUN, Chengdu, Sichuan (CN); Shitao HE, Chengdu, Sichuan (CN)

(21) Appl. No.: 18/691,549

(22) PCT Filed: Aug. 8, 2023
(86) PCT No.: PCT/CN2023/111606

§ 371 Date: Mar. 13, 2024

(30) Foreign Application Priority Data
Sep. 30, 2022 (CN) 202211205675.0

(51) Int. Cl. F24F 11/00; F24F 110/40; F24F 110/65

(52) U.S. Cl. CPC F24F 11/0001; F24F 2110/40; F24F 2110/65

(57) ABSTRACT

A dynamic control system for ventilation of a fully buried sewage treatment plant has a real-time dynamic monitoring module. The real-time dynamic monitoring module is used for monitoring a pressure difference value between a driving ramp and an outdoor environment, a harmful gas concentration value in each area or room and a pressure difference value of each area or room in real time; the dynamic control platform is in signal connection with the real-time dynamic monitoring module; the dynamic control platform calculates and adjusts the pressure difference set value of each area or room according to the control requirement of the real-time flow direction of the harmful gas, determines the air supplement amount of the current environment according to the real-time exhaust air amount and the real-time pressure difference air amount, and regulates and controls the rotating speed of an air supplement machine of the air supplement system.

### TECHNICAL FIELD

The present invention relates to the technical field on ventilation treatment of a fully buried sewage treatment plant, in particular to a dynamic control system and a control method suitable for ventilation of a fully buried sewage treatment plant.

### BACKGROUND

At present, the ventilation system control of the fully buried sewage treatment plant is designed for normal and emergency ventilation systems in different areas of the underground box at a fixed ventilation frequency according to corresponding specifications and recommendations. In this case, the coupling interference between different service areas is severe under the negative pressure inside the underground box of the fully buried sewage treatment plant, and emergency and normal ventilation mode switching in different areas is more likely to cause disorder in the airflow organization inside the fully buried sewage treatment plant, leading to odor overflow, accumulation of flammable and explosive gases, or corrosive gas entering the electrical control room.

### SUMMARY

The present invention is intended to solve at least one of the technical problems in the prior art.

Therefore, a first aspect of the present invention provides a dynamic control system suitable for ventilation of a fully buried sewage treatment plant.

A second aspect of the present invention provides a dynamic control method suitable for ventilation of a fully buried sewage treatment plant.

The present invention provides a dynamic control system suitable for ventilation of a fully buried sewage treatment plant, comprising:
a real-time dynamic monitoring module, wherein the real-time dynamic monitoring module is used for monitoring a pressure difference value between a driving ramp and an outdoor environment, a harmful gas concentration value in each area or room and a pressure difference value of each area or room in real time;
a dynamic control platform, being in signal connection with the real-time dynamic monitoring module, wherein the dynamic control platform is used for receiving the pressure difference value between the driving ramp and the outdoor environment, the harmful gas concentration value in each area or room and the pressure difference value of each area or room;
the dynamic control platform determines a real-time exhaust air amount of each area or room according to the harmful gas concentration value obtained in each area or room; and obtains the real-time pressure difference air amount according to the pressure difference value between the driving ramp and the outdoor environment, as well as the pressure difference value of each area or room; and calculates and adjusts the pressure difference set value of each area or room according to the control requirement of the real-time flow direction of the harmful gas, in order to obtain the required real-time pressure difference air amount;
the dynamic control platform determines the air supplement amount of the current environment according to the real-time exhaust air amount and the real-time pressure difference air amount, and regulates and controls the rotating speed of an air supplement machine of the air supplement system in real time according to the air supplement amount, so that the airflow flows from a harmless area to a harmful area, from high to low environmental requirements.

The dynamic control system suitable for ventilation of a fully buried sewage treatment plant proposed by the present invention consists of a real-time dynamic monitoring module and a dynamic control platform. The real-time dynamic monitoring module is used to monitor the pressure difference value between the driving ramp and the outdoor environment, the harmful gas concentration value in each area or room, and the pressure difference value of each area or room in real time. Due to different pressure difference values in each area or room, the required air supplement amount also varies. Therefore, the real-time dynamic monitoring module transmits the above data to the dynamic control platform, which processes and calculates the data. It should be noted that dynamic control platform can be a computer. When it receives the pressure difference value and needs to process the data, it adjusts the pressure difference set value of each area or room based on the control requirement of the real-time flow direction of the harmful gas (referring to the regulations of relevant national standards for indoor harmful gas concentration, that is, the indoor harmful gas concentration should be lower than the lower limit specified by the national standard to ensure indoor safety). This pressure difference set value is the pressure difference value (negative pressure state) that prevents the leakage of the harmful gas from the area or room, or the pressure difference that prevents the invasion of the harmful gas (positive pressure state). The specific adjustment method is to regulate and control the air supplement system and the exhaust system of this area or room, so that the pressure difference value in this area or room reaches the pressure difference set value in a manner of forming a pressure difference; Upon completion of the above process, the pressure difference air volume is obtained from the pressure difference value, and the real-time pressure difference air amount is usually obtained using its built-in calculation software according to the slot method or ventilation frequency method. The real-time pressure difference air amount is usually the natural air supplement for the gaps of doors and windows in the area or room, or the amount of indoor air overflow. After the dynamic control platform completes the above process, the real-time exhaust air amount is determined based on the obtained harmful gas concentration value in the area or room, combined with the performance curve of the exhaust fan of the exhaust system. Thus, the dynamic control platform obtains two parameters, real-time exhaust air amount and real-time pressure difference air amount. Finally, the difference or sum of the two parameters is used to determine the air supplement amount in the area or room. The air supplement amount is the amount of air that the air supplement system delivers to the area or room. By regulating and controlling the rotating speed of the air supplement machine, the airflow flows from a harmless area to a harmful area, from high to low environmental requirements. It should be noted that high environmental requirements are defined as areas or rooms with electronic control precision instruments and operators, where harmful gases are not allowed to enter, while low environmental requirements are defined as areas or rooms where some harmful gases are allowed to enter. According to the invention, the pressure difference value and harmful gas concentration in each area or room are uniformly transmitted to the dynamic control platform, the exhaust system and the air supplement system are uniformly managed and regulated by the dynamic control platform, and finally the controllable ventilation treatment of the fully buried sewage treatment plant is realized. The real-time dynamic monitoring module is responsible for independent real-time monitoring, while the dynamic control platform is responsible for the same processing and regulation & control process, ensuring the orderliness of ventilation treatment, thereby avoiding the problem of coupling interference between different service areas, and thus avoiding the disorder of airflow organization in the fully buried sewage treatment plant, leading to odor overflow, accumulation of flammable and explosive gases, or corrosive gas entering the electrical control room.

The dynamic control system suitable for ventilation of a fully buried sewage treatment plant according to the above technical solution of the present invention can also have the following additional technical features:

In the above technical solution, the air supplement amount of the certain area or room determined according to the following rules:
the pressure difference value between the driving ramp and the outdoor environment is regarded as a real-time base based on the pressure difference value between the driving ramp and the outdoor environment obtained from the real-time dynamic monitoring module, as well as the pressure difference value of each area or room;
the pressure difference value between the driving ramp and the outdoor environment is the real-time base, and the real-time base is increased or decreased accordingly according to the total leakage of the harmful gas from the whole buried sewage treatment plant, but the base is negative and the maximum value is not higher than −5 Pa;
all areas or rooms are sorted according to the real-time concentration value distribution of the harmful gases in all areas or rooms of the whole buried sewage treatment plant, as well as production safeguard levels and hazard levels;
for areas or rooms with high concentration values and hazard levels, the negative pressure value relative to the base is increased sequentially;
for areas or rooms with high production safeguard levels that do not emit harmful gases, the positive pressure value relative to the base is increased sequentially;
when the current environment of a certain area or room is in a negative pressure state, the air supplement amount is the difference value between the real-time exhaust air amount and the real-time pressure difference air amount;
when the current environment of a certain area or room is in a positive pressure state, the air supplement amount is the sum of the real-time exhaust air amount and the real-time pressure difference air amount.

In this technical solution, the pressure difference value between the driving ramp and the outdoor environment is defined as the real-time base. When the total leakage of harmful gases in the local buried sewage treatment plant (the total leakage of harmful gases in each area or room) increases, the real-time base needs to be increased. The specific adjustment method is to adjust the total air supplement system and total exhaust system of the whole buried sewage treatment plant, that is, the total air supplement amount decreases, while the total exhaust air amount increases. Accordingly, when the total leakage of harmful gases in the local buried sewage treatment plant (the total leakage of harmful gases in each area or room) decreases, the real-time base needs to be decreased. The specific adjustment method is to adjust the total air supplement system and total exhaust system of the whole buried sewage treatment plant, that is, the total air supplement amount increases, while the total exhaust air amount decreases. Upon determination of the real-time base, it is necessary to sort all areas or rooms according to the real-time concentration value distribution of the harmful gases in all areas or rooms of the whole buried sewage treatment plant, as well as production safeguard levels and hazard levels. Specifically, a high production safeguard level is defined as an area or room with high environmental requirements, while a low production safeguard level is defined as an area or room with lower environmental requirements. The hazard level is concluded based on the properties of the gas, such as explosiveness, corrosiveness, and other hazardous characteristics. For example, if the harmful gas concentration value of a certain area or room is high, and the harmful gases inside are all gases with hazardous characteristics, the negative pressure value relative to the real-time base needs to be increased in this area or room to avoid the leakage of harmful gases outwards. On the contrary, for areas or rooms that do not emit harmful gases and have high production safeguard levels, the positive pressure value relative to the base is sequentially increased, allowing internal gases to leak and circulate outwards.

In addition, this technical solution also has specific limitations on the calculation of the air supplement amount.

When the current environment is in a negative pressure state (defined as a negative pressure state if it is less than the real-time base), the air supplement amount is the difference value between the real-time exhaust air amount and the real-time pressure difference air amount, that is, the sum of the air supplement amount and the natural air supplement for the gaps of doors and windows in the area or room is the real-time exhaust air amount, thereby achieving air amount balance in the area or room, ensuring gas flow, and reducing the overflow of harmful gases;

When the current environment is in a positive pressure state (defined as a positive pressure state if it is less than the real-time base), the air supplement amount is the sum of the real-time exhaust air amount and the real-time pressure difference air amount, that is, the sum of the real-time exhaust air amount and the amount of indoor air overflow is the air supplement amount, 0 thereby achieving air amount balance in the area or room, ensuring gas flow, and reducing the invasion of harmful gases.

In the above technical solution, when the dynamic control platform obtains the pressure difference value between the driving ramp and the outdoor environment, as well as the pressure difference value of each area or room, the real-time pressure difference air amount is determined in real time using the slot method or ventilation frequency method.

In this technical solution, after obtaining the pressure difference value, the dynamic control platform obtains the real-time pressure difference air amount using the slot method or ventilation frequency method. This real-time pressure difference air amount is used to calculate the air supplement amount.

In the above technical solution, the harmful gas concentration value is monitored by harmful gas concentration sensors; there are multiple harmful gas concentration sensors which are in signal connection with the dynamic control platform; the multiple harmful gas concentration sensors are arranged in each area or room.

In this technical solution, the harmful gas concentration sensors are used to monitor the harmful gas concentrations in the areas or rooms. The specifications and models are not specifically limited here, and sensors that meet the requirements can be used based on the size of the area or room. There are multiple harmful gas concentration sensors which are arranged in each area or room, independent of each other without interfering with each other. Each harmful gas concentration sensor is in signal connection with the dynamic control platform to upload the harmful gas concentration value in this area or room.

In the above technical solution, the pressure difference value is monitored by the pressure difference sensor, and there are multiple pressure difference sensors, which are in signal connection with the dynamic control platform; the multiple pressure difference sensors are arranged in each room or area.

In this technical solution, the pressure difference sensor is used to monitor the pressure difference value in the area or room. The specifications and models are not specifically limited here, and sensors that meet the requirements can be used based on the size of the area or room. There are multiple pressure difference sensors which are arranged in each area or room, independent of each other without interfering with each other. Each pressure difference sensor is in signal connection with the dynamic control platform to upload the pressure difference value in this area or room.

In the above technical solution, the pressure difference value is the difference value between the air supplement amount of the air supplement system and the exhaust air amount of the exhaust system in the room or area.

In this technical solution, the pressure difference value is the difference value between the air supplement amount of the air supplement system and the exhaust air amount of the exhaust system in the room or area. When the air supplement amount is greater than the exhaust air amount, the area or room is in the positive pressure state, and when the air supplement amount is smaller than the exhaust air amount, the area or room is in the negative pressure state.

In the above technical solution, the air supplement amount is the air amount conveyed by the air supplement system to the area or room;
the exhaust air amount is the air amount exhausted by the exhaust system to the outside of the area or room.

In this technical solution, the air supplement amount and the exhaust air amount are explained specifically.

In the above technical solution, the air supplement system and the exhaust system at least include an air supplement unit and an air exhaust unit, and the air supplement unit and the air exhaust unit are electrically connected to the dynamic control platform.

In this technical solution, the air supplement unit of the air supplement system and the air exhaust unit of the exhaust system are both regulated and controlled uniformly by the dynamic control platform; when the harmful gas concentration in the area or room is higher, the rotating speed of the air exhaust unit is increased to increase the exhaust air amount.

The present invention also provides a dynamic control method suitable for ventilation of a fully buried sewage treatment plant, comprising the following steps:
obtaining a pressure difference value between a driving ramp and an outdoor environment, a harmful gas concentration value in each area or room and a pressure difference value of each area or room in real time;
determining a real-time exhaust air amount of each area or room according to the harmful gas concentration value obtained in each area or room; and calculating and adjusting the pressure difference set value of each area or room according to the control requirement of the real-time flow direction of the harmful gas, in order to obtain the required real-time pressure difference air amount;
determining the air supplement amount of the current environment according to the real-time exhaust air amount and the real-time pressure difference air amount, and regulating and controlling the rotating speed of an air supplement machine of the air supplement system in real time according to the air supplement amount, so that the airflow flows from a harmless area to a harmful area, from high to low environmental requirements. This control method has all the beneficial effects of the above technical solutions, and will not be repeated here.

The additional aspects and advantages of the present invention would become clear from the description below or would be understood through the practice of the present invention.

### BRIEF DESCRIPTION OF THE DRAWINGS

The aspects and advantages mentioned above and/or attached would be clear and easy to understand through the description of embodiments combining the following drawings, wherein:

FIG. 1 is a system diagram of the dynamic control system of the present invention suitable for ventilation of a fully buried sewage treatment plant;

FIG. 2 is a schematic diagram of the dynamic control system of the present invention suitable for ventilation of a fully buried sewage treatment plant;

### DETAILED DESCRIPTION OF THE PREFERRED EMBODIMENTS

The present invention will be further described in detail in combination with accompanied drawings and embodiments for clear understanding of the purpose, features and advantages of the invention. It should be noted that the features in the embodiments and the embodiments of the present application may be combined with each other in a non-conflicting situation.

In the following description, numerous specific details are set forth in order to provide a thorough understanding of the present invention. However, the present invention may also be implemented in other ways different from those described here, so the protection scope of the present invention is not limited by the specific embodiments disclosed below.

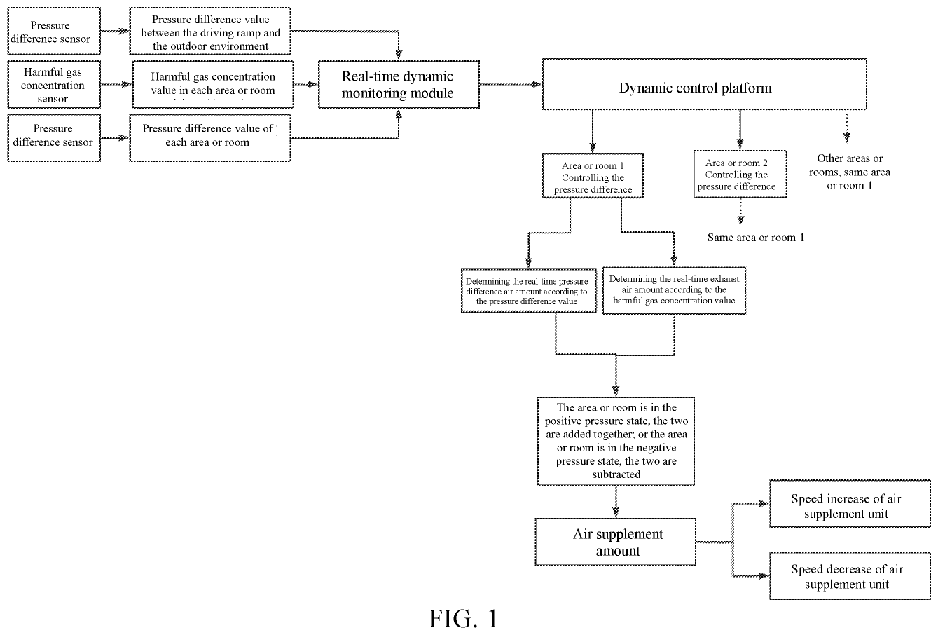

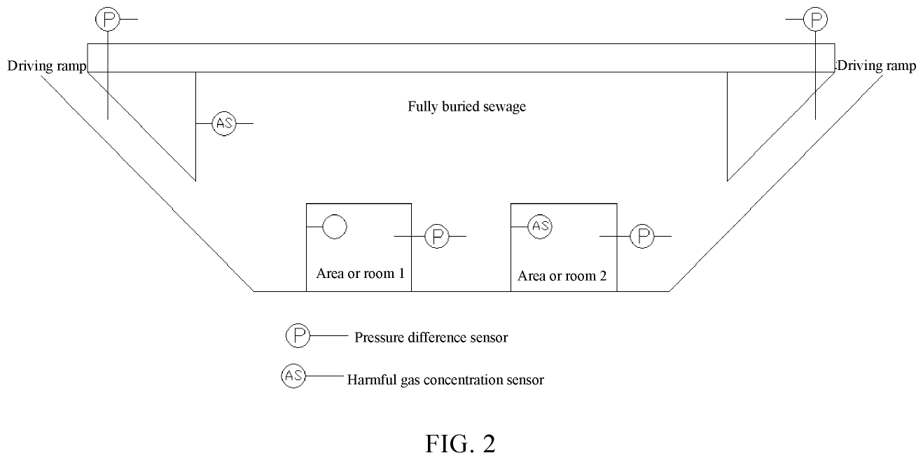

The dynamic control system and the control method suitable for ventilation of a fully buried sewage treatment plant provided by some embodiments of the present invention are described by reference to FIG. 1 and FIG. 2 below.

Some embodiments of the present application provide a dynamic control system and a control method suitable for ventilation of a fully buried sewage treatment plant.

As shown in FIG. 1 and FIG. 2, the first embodiment of the present invention provides a dynamic control system suitable for ventilation of a fully buried sewage treatment plant, comprising:
a real-time dynamic monitoring module, wherein the real-time dynamic monitoring module is used for monitoring a pressure difference value between a driving ramp and an outdoor environment, a harmful gas concentration value in each area or room and a pressure difference value of each area or room in real time;
a dynamic control platform, being in signal connection with the real-time dynamic monitoring module, wherein the dynamic control platform is used for receiving the pressure difference value between the driving ramp and the outdoor environment, the harmful gas concentration value in each area or room and the pressure difference value of each area or room;
the dynamic control platform determines a real-time exhaust air amount of each area or room according to the harmful gas concentration value obtained in each area or room; and obtains the real-time pressure difference air amount according to the pressure difference value between the driving ramp and the outdoor environment, as well as the pressure difference value of each area or room; and calculates and adjusts the pressure difference set value of each area or room according to the control requirement of the real-time flow direction of the harmful gas, in order to obtain the required real-time pressure difference air amount;
the dynamic control platform determines the air supplement amount of the current environment according to the real-time exhaust air amount and the real-time pressure difference air amount, and regulates and controls the rotating speed of an air supplement machine of the air supplement system in real time according to the air supplement amount, so that the airflow flows from a harmless area to a harmful area, from high to low environmental requirements.

The dynamic control system suitable for ventilation of a fully buried sewage treatment plant proposed by the present invention consists of a real-time dynamic monitoring module and a dynamic control platform. The real-time dynamic monitoring module is used to monitor the pressure difference value between the driving ramp and the outdoor environment, the harmful gas concentration value in each area or room, and the pressure difference value of each area or room in real time. Due to different pressure difference values in each area or room, the required air supplement amount also varies. Therefore, the real-time dynamic monitoring module transmits the above data to the dynamic control platform, which processes and calculates the data. It should be noted that dynamic control platform can be a computer. When it receives the pressure difference value and needs to process the data, it adjusts the pressure difference set value of each area or room based on the control requirement of the real-time flow direction of the harmful gas (referring to the regulations of relevant national standards for indoor harmful gas concentration, that is, the indoor harmful gas concentration should be lower than the lower limit specified by the national standard to ensure indoor safety). This pressure difference set value is the pressure difference value (negative pressure state) that prevents the leakage of the harmful gas from the area or room, or the pressure difference that prevents the invasion of the harmful gas (positive pressure state). The specific adjustment method is to regulate and control the air supplement system and the exhaust system of this area or room, so that the pressure difference value in this area or room reaches the pressure difference set value in a manner of forming a pressure difference; Upon completion of the above process, the pressure difference air volume is obtained from the pressure difference value, and the real-time pressure difference air amount is usually obtained using its built-in calculation software according to the slot method or ventilation frequency method. The real-time pressure difference air amount is usually the natural air supplement for the gaps of doors and windows in the area or room, or the amount of indoor air overflow. After the dynamic control platform completes the above process, the real-time exhaust air amount is determined based on the obtained harmful gas concentration value in the area or room, combined with the performance curve of the exhaust fan of the exhaust system. Thus, the dynamic control platform obtains two parameters, real-time exhaust air amount and real-time pressure difference air amount. Finally, the difference or sum of the two parameters is used to determine the air supplement amount in the area or room. The air supplement amount is the amount of air that the air supplement system delivers to the area or room. By regulating and controlling the rotating speed of the air supplement machine, the airflow flows from a harmless area to a harmful area, from high to low environmental requirements. It should be noted that high environmental requirements are defined as areas or rooms with electronic control precision instruments and operators, where harmful gases are not allowed to enter, while low environmental requirements are defined as areas or rooms where some harmful gases are allowed to enter. According to the invention, the pressure difference value and harmful gas concentration in each area or room are uniformly transmitted to the dynamic control platform, the exhaust system and the air supplement system are uniformly managed and regulated by the dynamic control platform, and finally the controllable ventilation treatment of the fully buried sewage treatment plant is realized. The real-time dynamic monitoring module is responsible for independent real-time monitoring, while the dynamic control platform is responsible for the same processing and regulation & control process, ensuring the orderliness of ventilation treatment, thereby avoiding the problem of coupling interference between different service areas, and thus avoiding the disorder of airflow organization in the fully buried sewage treatment plant, leading to odor overflow, accumulation of flammable and explosive gases, or corrosive gas entering the electrical control room.

The second embodiment of the present invention provides a dynamic control system suitable for ventilation of a fully buried sewage treatment plant, and based on the first embodiment, the air supplement amount is determined according to the following rules:
the air supplement amount of the certain area or room is determined according to the following rules:
the pressure difference value between the driving ramp and the outdoor environment is regarded as a real-time base based on the pressure difference value between the driving ramp and the outdoor environment obtained from the real-time dynamic monitoring module, as well as the pressure difference value of each area or room;
the pressure difference value between the driving ramp and the outdoor environment is the real-time base, and the real-time base is increased or decreased accordingly according to the total leakage of the harmful gas from the whole buried sewage treatment plant, but the base is negative and the maximum value is not higher than −5 Pa;
all areas or rooms are sorted according to the real-time concentration value distribution of the harmful gases in all areas or rooms of the whole buried sewage treatment plant, as well as production safeguard levels and hazard levels;
for areas or rooms with high concentration values and hazard levels, the negative pressure value relative to the base is increased sequentially;
for areas or rooms with high production safeguard levels that do not emit harmful gases, the positive pressure value relative to the base is increased sequentially;
when the current environment of a certain area or room is in a negative pressure state, the air supplement amount is the difference value between the real-time exhaust air amount and the real-time pressure difference air amount;
when the current environment of a certain area or room is in a positive pressure state, the air supplement amount is the sum of the real-time exhaust air amount and the real-time pressure difference air amount.

In this technical solution, the pressure difference value between the driving ramp and the outdoor environment is defined as the real-time base. When the total leakage of harmful gases in the local buried sewage treatment plant (the total leakage of harmful gases in each area or room) increases, the real-time base needs to be increased. The specific adjustment method is to adjust the total air supplement system and total exhaust system of the whole buried sewage treatment plant, that is, the total air supplement amount decreases, while the total exhaust air amount increases. Accordingly, when the total leakage of harmful gases in the local buried sewage treatment plant (the total leakage of harmful gases in each area or room) decreases, the real-time base needs to be decreased. The specific adjustment method is to adjust the total air supplement system and total exhaust system of the whole buried sewage treatment plant, that is, the total air supplement amount increases, while the total exhaust air amount decreases. Upon determination of the real-time base, it is necessary to sort all areas or rooms according to the real-time concentration value distribution of the harmful gases in all areas or rooms of the whole buried sewage treatment plant, as well as production safeguard levels and hazard levels. Specifically, a high production safeguard level is defined as an area or room with high environmental requirements, while a low production safeguard level is defined as an area or room with lower environmental requirements. The hazard level is concluded based on the properties of the gas, such as explosiveness, corrosiveness, and other hazardous characteristics. For example, if the harmful gas concentration value of a certain area or room is high, and the harmful gases inside are all gases with hazardous characteristics, the negative pressure value relative to the real-time base needs to be increased in this area or room to avoid the leakage of harmful gases outwards. Conversely, for areas or rooms that do not emit harmful gases and have high production safeguard levels, the positive pressure value relative to the base is sequentially increased, allowing internal gases to leak and circulate outwards.

In addition, this technical solution also has specific limitations on the calculation of the air supplement amount.

When the current environment is in a negative pressure state (defined as a negative pressure state if it is less than the real-time base), the air supplement amount is the difference value between the real-time exhaust air amount and the real-time pressure difference air amount, that is, the sum of the air supplement amount and the natural air supplement for the gaps of doors and windows in the area or room is the real-time exhaust air amount, thereby achieving air amount balance in the area or room, ensuring gas flow, and reducing the overflow of harmful gases;

When the current environment is in a positive pressure state (defined as a positive pressure state if it is less than the real-time base), the air supplement amount is the sum of the real-time exhaust air amount and the real-time pressure difference air amount, that is, the sum of the real-time exhaust air amount and the amount of indoor air overflow is the air supplement amount, 0 thereby achieving air amount balance in the area or room, ensuring gas flow, and reducing the invasion of harmful gases.

The third embodiment of the present invention provides a dynamic control system suitable for ventilation of a fully buried sewage treatment plant, and based on either of the above embodiments, when the dynamic control platform obtains the pressure difference value between the driving ramp and the outdoor environment, as well as the pressure difference value of each area or room, the real-time pressure difference air amount is determined in real time using the slot method or ventilation frequency method.

In this embodiment, after obtaining the pressure difference value, the dynamic control platform obtains the real-time pressure difference air amount using the slot method or ventilation frequency method. This real-time pressure difference air amount is used to calculate the air supplement amount.

The fourth embodiment of the present invention provides a dynamic control system suitable for ventilation of a fully buried sewage treatment plant, and based on any of the above embodiments, the harmful gas concentration value is monitored by harmful gas concentration sensors; there are multiple harmful gas concentration sensors which are in signal connection with the dynamic control platform; the multiple harmful gas concentration sensors are arranged in each area or room.

In this embodiment, the harmful gas concentration sensors are used to monitor the harmful gas concentrations in the areas or rooms. The specifications and models are not specifically limited here, and sensors that meet the requirements can be used based on the size of the area or room. There are multiple harmful gas concentration sensors which are arranged in each area or room, independent of each other without interfering with each other. Each harmful gas concentration sensor is in signal connection with the dynamic control platform to upload the harmful gas concentration value in this area or room.

The fifth embodiment of the present invention provides a dynamic control system suitable for ventilation of a fully buried sewage treatment plant, and based on any of the above embodiments, the pressure difference value is monitored by pressure difference sensors; there are multiple pressure difference sensors which are in signal connection with the dynamic control platform; the multiple pressure difference sensors are arranged in each area or room.

In this embodiment, the pressure difference sensor is used to monitor the pressure difference value in the area or room. The specifications and models are not specifically limited here, and sensors that meet the requirements can be used based on the size of the area or room. There are multiple pressure difference sensors which are arranged in each area or room, independent of each other without interfering with each other. Each pressure difference sensor is in signal connection with the dynamic control platform to upload the pressure difference value in this area or room.

The sixth embodiment of the present invention provides a dynamic control system suitable for ventilation of a fully buried sewage treatment plant, and based on any of the above embodiments, the pressure difference value is difference value between the air supplement amount of the air supplement system and the exhaust air amount of the exhaust system in the room or area.

In this embodiment, the pressure difference value is the difference value between the air supplement amount of the air supplement system and the exhaust air amount of the exhaust system in the room or area. When the air supplement amount is greater than the exhaust air amount, the area or room is in the positive pressure state, and when the air supplement amount is smaller than the exhaust air amount, the area or room is in the negative pressure state.

The seventh embodiment of the present invention provides a dynamic control system suitable for ventilation of a fully buried sewage treatment plant, and based on any of the above embodiments, the air supplement amount is the amount of air that the air supplement system delivers to the area or room.
the exhaust air amount is the air amount exhausted by the exhaust system to the outside of the area or room.

In this embodiment, the air supplement amount and the exhaust air amount are explained specifically.

The eighth embodiment of the present invention provides a dynamic control system suitable for ventilation of a fully buried sewage treatment plant, and based on any of the above embodiments, the air supplement system and the exhaust system at least include an air supplement unit and an air exhaust unit, and the air supplement unit and the air exhaust unit are electrically connected to the dynamic control platform.

In this embodiment, the air supplement unit of the air supplement system and the air exhaust unit of the exhaust system are both regulated and controlled uniformly by the dynamic control platform; when the harmful gas concentration in the area or room is higher, the rotating speed of the air exhaust unit is increased to increase the exhaust air amount.

The ninth embodiment of the present invention also provides a dynamic control method suitable for ventilation of a fully buried sewage treatment plant, comprising the following steps:
obtaining a pressure difference value between a driving ramp and an outdoor environment, a harmful gas concentration value in each area or room and a pressure difference value of each area or room in real time;
determining a real-time exhaust air amount of each area or room according to the harmful gas concentration value obtained in each area or room; and calculating and adjusting the pressure difference set value of each area or room according to the control requirement of the real-time flow direction of the harmful gas, in order to obtain the required real-time pressure difference air amount;
determining the air supplement amount of the current environment according to the real-time exhaust air amount and the real-time pressure difference air amount, and regulating and controlling the rotating speed of an air supplement machine of the air supplement system in real time according to the air supplement amount, so that the airflow flows from a harmless area to a harmful area, from high to low environmental requirements. This control method has all the beneficial effects of the above technical solutions, and will not be repeated here.

In the Description, the illustrative expressions of the above terms do not necessarily refer to the same embodiment or example. Moreover, the specific features, structures, materials or characteristics described may be appropriately combined in any one or more embodiments or examples.

Any modification, equivalent replacement and improvement made within the spirit and rule of the present invention shall be incorporated in the protection scope of the present invention.

1. A dynamic control system suitable for ventilation of a fully buried sewage treatment plant, characterized by, comprising:
a real-time dynamic monitoring module, wherein the real-time dynamic monitoring module is used for monitoring a pressure difference value between a driving ramp and an outdoor environment, a harmful gas concentration value in each area or room and a pressure difference value of each area or room in real time;
a dynamic control platform, being in signal connection with the real-time dynamic monitoring module, wherein the dynamic control platform is used for receiving the pressure difference value between the driving ramp and the outdoor environment, the harmful gas concentration value in each area or room and the pressure difference value of each area or room;
the dynamic control platform determines a real-time exhaust air amount of each area or room according to the harmful gas concentration value obtained in each area or room; and calculates a pressure difference set value of the area or room according to the control requirement of the real-time flow direction of the harmful gas, the pressure difference set value is the pressure difference value that prevents the leakage of the harmful gas from the area or room, i.e., negative pressure value, or the pressure difference value that prevents the invasion of the harmful gas, i.e., positive pressure value, and then, obtains the real-time pressure difference air amount using a slot method or a ventilation frequency method; adjusts the air supplement system and the exhaust system of the area or room according to the control requirement of the real-time flow direction of the harmful gas, so that the pressure difference value in the area or room reaches the pressure difference set value in a manner of forming a pressure difference;
the dynamic control platform determines the air supplement amount of the current environment according to the real-time exhaust air amount and the real-time pressure difference air amount, and regulates and controls the rotating speed of an air supplement machine of the air supplement system in real time according to the air supplement amount, so that the airflow flows from a harmless area to a harmful area, from high to low environmental requirements;
the air supplement amount of a certain area or room is determined according to the following rules:
the pressure difference value between the driving ramp and the outdoor environment is regarded as a real-time base based on the pressure difference value between the driving ramp and the outdoor environment obtained from the real-time dynamic monitoring module, as well as the pressure difference value of each area or room;
the pressure difference value between the driving ramp and the outdoor environment is the real-time base, and the real-time base is increased or decreased accordingly according to the total leakage of the harmful gas from the whole buried sewage treatment plant, but the base is negative and the maximum value is not higher than −5 Pa;
all areas or rooms are sorted according to the real-time concentration value distribution of the harmful gases in all areas or rooms of the whole buried sewage treatment plant, as well as environmental requirements and hazard levels;
for areas or rooms with high concentration values and hazard levels, the negative pressure value relative to the real-time base is increased sequentially;
for harmless areas or rooms with high environmental requirements and hazard levels, the positive pressure value relative to the real-time base is increased sequentially;
when the current environment of a certain area or room is in a negative pressure state, the air supplement amount is the difference value between the real-time exhaust air amount and the real-time pressure difference air amount; and
when the current environment of a certain area or room is in a positive pressure state, the air supplement amount is the sum of the real-time exhaust air amount and the real-time pressure difference air amount.

2. The dynamic control system suitable for ventilation of a fully buried sewage treatment plant according to claim 1, characterized in that, when the dynamic control platform obtains the pressure difference value between the driving ramp and the outdoor environment, as well as the pressure difference value of each area or room, the real-time pressure difference air amount is determined in real time using the slot method or ventilation frequency method.

3. The dynamic control system suitable for ventilation of a fully buried sewage treatment plant according to claim 2, characterized in that, the harmful gas concentration value is monitored by harmful gas concentration sensors; there are multiple harmful gas concentration sensors which are in signal connection with the dynamic control platform; the multiple harmful gas concentration sensors are arranged in each area or room.

4. The dynamic control system suitable for ventilation of a fully buried sewage treatment plant according to claim 3, characterized in that, the pressure difference value is monitored by pressure difference sensors; there are multiple pressure difference sensors which are in signal connection with the dynamic control platform; the multiple pressure difference sensors are arranged in each area or room.

5. The dynamic control system suitable for ventilation of a fully buried sewage treatment plant according to claim 4, characterized in that, the pressure difference value is difference value between the air supplement amount of the air supplement system and the exhaust air amount of the exhaust system in the room or area.

6. The dynamic control system suitable for ventilation of a fully buried sewage treatment plant according to claim 5, characterized in that,
the air supplement amount is the air amount conveyed by the air supplement system to the area or room; and
the exhaust air amount is the air amount exhausted by the exhaust system to the outside of the area or room.

7. The dynamic control system suitable for ventilation of a fully buried sewage treatment plant according to claim 6, characterized in that,
the air supplement system and the exhaust system at least include an air supplement unit and an air exhaust unit, and the air supplement unit and the air exhaust unit are electrically connected to the dynamic control platform.

8. A dynamic control method suitable for ventilation of a fully buried sewage treatment plant, applied to the dynamic control system suitable for ventilation of a fully buried sewage treatment plant according to claim 1, characterized by, comprising the following steps:
obtaining a pressure difference value between a driving ramp and an outdoor environment, a harmful gas concentration value in each area or room and a pressure difference value of each area or room in real time;
determining a real-time exhaust air amount of each area or room according to the harmful gas concentration value obtained in each area or room; and calculating a pressure difference set value of the area or room according to the control requirement of the real-time flow direction of the harmful gas, the pressure difference set value being the pressure difference value that prevents the leakage of the harmful gas from the area or room, i.e., negative pressure value, or the pressure difference value that prevents the invasion of the harmful gas, i.e., positive pressure value, and then, obtaining the real-time pressure difference air amount using a slot method or a ventilation frequency method; adjusting the air supplement system and the exhaust system of the area or room according to the control requirement of the real-time flow direction of the harmful gas, so that the pressure difference value in the area or room reaches the pressure difference set value in a manner of forming a pressure difference; and
determining the air supplement amount of the current environment according to the real-time exhaust air amount and the real-time pressure difference air amount, and regulating and controlling the rotating speed of an air supplement machine of the air supplement system in real time according to the air supplement amount, so that the airflow flows from a harmless area to a harmful area, from high to low environmental requirements;
wherein the air supplement amount of a certain area or room being determined according to the following rules:
the pressure difference value between the driving ramp and the outdoor environment is regarded as a real-time base based on the pressure difference value between the driving ramp and the outdoor environment obtained from the real-time dynamic monitoring module, as well as the pressure difference value of each area or room;
the pressure difference value between the driving ramp and the outdoor environment is the real-time base, and the real-time base is increased or decreased accordingly according to the total leakage of the harmful gas from the whole buried sewage treatment plant, but the base is negative and the maximum value is not higher than −5 Pa;
all areas or rooms are sorted according to the real-time concentration value distribution of the harmful gases in all areas or rooms of the whole buried sewage treatment plant, as well as environmental requirements and hazard levels;
for areas or rooms with high concentration values and hazard levels, the negative pressure value relative to the real-time base is increased sequentially;
for harmless areas or rooms with high environmental requirements and hazard levels, the positive pressure value relative to the real-time base is increased sequentially;
when the current environment of a certain area or room is in a negative pressure state, the air supplement amount is the difference value between the real-time exhaust air amount and the real-time pressure difference air amount; and
when the current environment of a certain area or room is in a positive pressure state, the air supplement amount is the sum of the real-time exhaust air amount and the real-time pressure difference air amount.
